(19) United States
(12) Patent Application Publication
(10) Pub. No.: US 2019/0132165 A1
(43) Pub. Date: May 2, 2019

(54) METHOD OF RECEIVING OR TRANSMITTING DATA BY UE OR BASE STATION UNDER NOMA SCHEME, UE USING THE SAME AND BASE STATION USING THE SAME

(71) Applicant: Industrial Technology Research Institute, Hsinchu (TW)

(72) Inventors: Shin-Lin Shieh, Hsinchu County (TW); Chia-Hung Lin, Tainan City (TW)

(73) Assignee: Industrial Technology Research Institute, Hsinchu (TW)

(21) Appl. No.: 16/172,889

(22) Filed: Oct. 29, 2018

Related U.S. Application Data
(60) Provisional application No. 62/580,022, filed on Nov. 1, 2017.

(51) Int. Cl. H04L 27/18; H04L 1/00; H04J 99/00; H04W 52/16; H04L 27/26

(52) U.S. Cl. CPC H04L 27/18; H04L 1/0003; H04J 15/00; H04B 7/0413; H04W 52/16; H04L 27/2691; H04L 27/2697; H04L 1/0009

(57) ABSTRACT

The disclosure provides a method of receiving or transmitting data by a UE or by a base station which operates under a NOMA scheme, a UE using the same method, and a base station using the same method. According to one of the exemplary embodiments, the method would include not limited to: receiving, within a same physical resource, a combined signal having a first signal and a second signal that are superimposed on each other; applying a phase rotation information for the first signal and the second signal; removing, from the combined signal, the second signal based on the phase rotation information; and decoding the first signal from the combined signal.

### CROSS REFERENCE TO RELATED APPLICATION

This application claims the priority benefit of U.S. provisional application Ser. No. 62/580,022, filed on Nov. 1, 2017. The entirety of the above-mentioned patent application is hereby incorporated by reference herein and made a part of specification.

### TECHNICAL FIELD

The present disclosure is directed to a method of receiving or transmitting data by a UE or by a base station which operates under a Non-Orthogonal Multiple Access (NOMA) scheme, a UE using the same method, and a base station using the same method.

### BACKGROUND

Conventionally, Non-orthogonal Multiple Access (NOMA) has been considered an emerging radio access technique to be used in the next-generation wireless communication system. Relative to Orthogonal Frequency Division Multiple Access (OFDMA), NOMA offers potential benefits which includes increased spectrum efficiency, reduced latency, massive connectivity, and so forth. Moving toward NOMA would enable a wireless communication network to serve multiple users by using the same time slot, the same frequency, and the same space. The NOMA scheme has the potential to be applied in various fifth generation (5G) communication scenarios including Machine-to-Machine (M2M) communications and the Internet-of-Things (IoT). NOMA may also be readily integrated with various effective wireless communications techniques, such as cooperative communications, multiple-input multiple-output (MIMO), beamforming, space-time coding, network coding, full-duplex, etc.

NOMA can be divided into several categories which may include power domain, code based, sequence based, interleaver, scrambler, etc. Among the several categories of NOMA, power domain NOMA and code domain NOMA are the categories that are discussed the most. Essentially, power domain NOMA functions by multiplexing users in the power domain, and code domain NOMA functions by multiplexing users in the code domain. Since this disclosure focuses on power domain NOMA, power domain NOMA will be shorthanded as simply “NOMA” in the rest of this disclosure. The advantage of power domain NOMA relative to other categories of NOMA is that less redesign efforts are required to bring current UEs to be in line with a power domain NOMA scheme since power domain NOMA has already been adopted in LTE downlink NOMA scheme.

FIG. 1 illustrates an existing NOMA technique. In FIG. 1, a base station 111 would transmit and receive at least two different signals that are superimposed in the same frequency spectrum from at least two different user equipment which are UE 101 and UE 102 in this example. The first UE 101 may transmit with a larger channel gain from the second UE 102 and thus the received power level of the first UE 101 would be higher than the second UE 102. In order for the receiver of the base station 111 to decode signals from the two UEs 101 102, in step S121, the base station 111 would first decode the signal of the first UE 101 from a superimposed signal which includes a signal from the first UE 101 and a signal from a second UE 102. The signal from the first UE is received with a higher power level than the signal received from the second UE 102 In step S122, the base station 111 would perform a successive interference cancellation (SIC) procedure by subtracting signal of the first UE 101. In step S123, the base station would decode the signal of the second UE 102 from the signal which has cancelled the signal of the first UE 101.

FIG. 2 illustrates another example of an existing NOMA technique. In this example, the first UE 201 is assumed to operate under a stronger channel gain but a weaker signal power than the second UE 202, and the two UEs 201 202 would receive a superimposed signal from a base station 203. Since first UE 201 operate under a weaker signal power, the first UE 201 needs to subtract the interference signal from the second UE 202 while the second UE 202 can perform signal detection without a performing SIC procedure.

In general, when operating under a NOMA scheme, a base station would transmit an encoded signal for each user which are superimposed within a physical resource as a sum of all messages of the users. The users are arranged with respect to their effective channel gains with the lowest gain at the bottom of the sequence while the one with the highest gain is at the top with other users arranged in between. For the reason of fairness, NOMA would ensure that the users with less gain would operate under higher power than users with higher gain. However, since NOMA would allow multiple users to be superimposed on the same physical resource, by doing so, the gaps of power levels among each UE could be small as it would degrade the performance of NOMA. Consequently, a modification of the existing transmission technique under power domain NOMA would be needed in order to enhance resource management and to minimize interferences.

### SUMMARY OF THE DISCLOSURE

Accordingly, the disclosure is directed to a method of receiving or transmitting data by a UE or by a base station which operates under a Non-Orthogonal Multiple Access (NOMA) scheme, a UE using the same method, and a base station using the same method.

In one of the exemplary embodiments, the disclosure is directed to a method of receiving data by a UE which operates under a Non-Orthogonal Multiple Access (NOMA) scheme, and the method would include not limited to: receiving, within a same physical resource, a combined signal having a first signal and a second signal that are superimposed on each other; applying a phase rotation information for the first signal and the second signal; removing, from the combined signal, the second signal based on the phase rotation information; and decoding the first signal from the combined signal.

In one of the exemplary embodiments, the disclosure is directed to a method of transmitting data by a base station which operates under a Non-Orthogonal Multiple Access (NOMA) scheme, and the method would include not limited to: transmitting a phase rotation information; receiving, within a same physical resource, a combined signal comprising a first signal and a second signal that are superimposed on each other; decoding, from the combined signal, the first signal; and decoding, from the combined signal, the second signal based on the phase rotation information.

In one of the exemplary embodiments, the disclosure is directed to a UE which includes not limited to: a hardware transceiver; and a hardware processor electrically connected to the hardware transceiver and configured at least to: receive, within a same physical resource, a combined signal having a first signal and a second signal that are superimposed on each other; apply a phase rotation information for the first signal and the second signal; remove, from the combined signal, the second signal based on the phase rotation information; and decode the first signal from the combined signal.

In order to make the aforementioned features and advantages of the present disclosure comprehensible, exemplary embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspects and embodiments of the present disclosure and is therefore not meant to be limiting or restrictive in any manner. Also, the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates an existing power domain NOMA technique.

FIG. 2 illustrates a typical power domain NOMA technique which multiplexes multiple users by performing SIC at a receiver of a base station.

FIG. 3 illustrates a signal constellation diagram of a power domain NOMA technique in accordance with one of the exemplary embodiments of the disclosure.

FIG. 4 illustrates a plot showing minimum distances as a function of power ratio under a power domain NOMA technique of QPSK+QPSK in accordance with one of the exemplary embodiments of the disclosure.

FIG. 5 illustrates a first exemplary embodiment of a method of transmitting data under NOMA scheme.

FIG. 6 illustrates a second exemplary embodiment of a method of transmitting data under NOMA scheme.

FIG. 7 illustrates a third exemplary embodiment of a method of transmitting data under NOMA scheme.

FIG. 8 illustrates a fourth exemplary embodiment of a method of transmitting data under NOMA scheme.

FIG. 9 illustrates a method of transmitting data under NOMA scheme from the perspective of a user equipment.

FIG. 10 illustrates a hardware diagram of a user equipment in terms of functional block diagrams in accordance with one of the exemplary embodiments of the disclosure.

FIG. 11 illustrates a method of transmitting data under NOMA scheme from the perspective of a base station.

FIG. 12 illustrates a hardware diagram of a base station in terms of functional block diagrams in accordance with one of the exemplary embodiments of the disclosure.

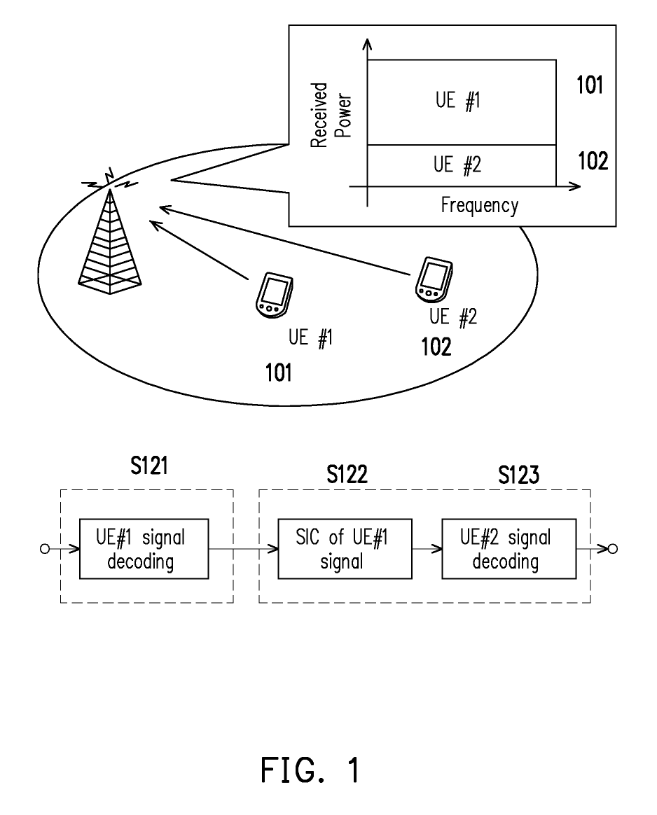

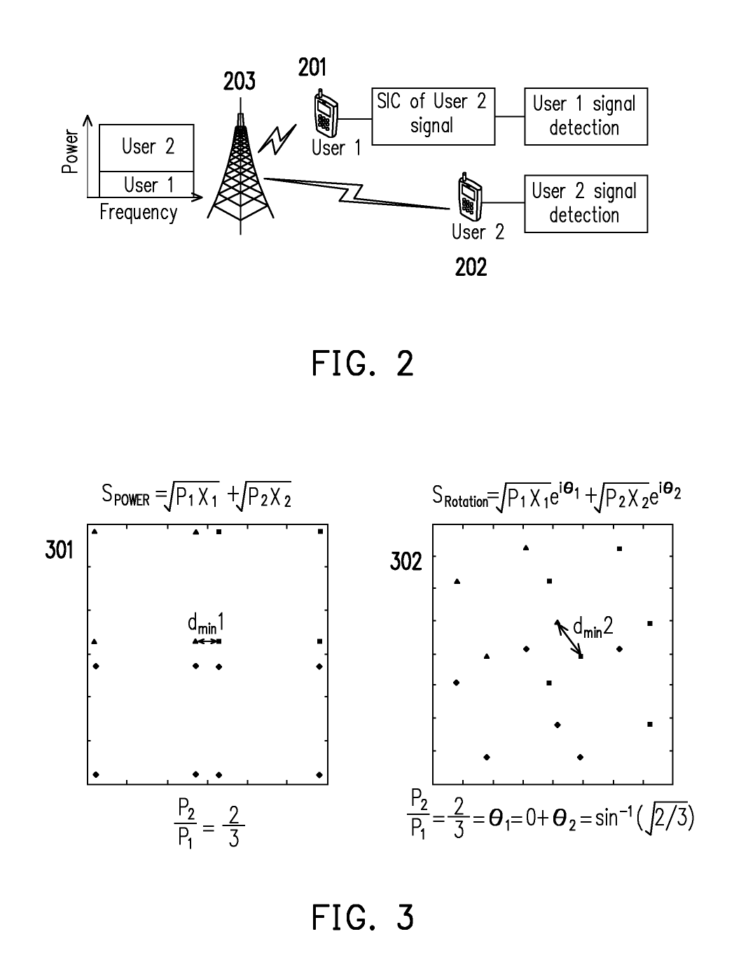

### DETAILED DESCRIPTION OF DISCLOSED EMBODIMENTS

Reference will now be made in detail to the present exemplary embodiments of the disclosure, examples of which are illustrated in the accompanying drawings. Wherever possible, the same reference numbers are used in the drawings and the description to refer to the same or like parts.

Non-orthogonal multiple access (NOMA) has recently emerged as a promising multiple access technique for LTE enhancements and 5G due to its better cell coverage and potentially higher throughput than the traditional orthogonal multiple access (OMA). Under NOMA, signals would be superimposed under two or more constellations in the power domain. In this disclosure, a concept of inter-constellation rotation would be proposed based on several schemes including the minimum distance (MD) criterion, mutual information (MI) criterion, and random rotation criterion over downlink/uplink (DL/UL) NOMA scenario. In comparison with traditional power domain NOMA, inter-constellation rotation schemes would achieve a more robust error performance.

Thus, the disclosure provides a method of transmitting data by a UE under a Non-Orthogonal Multiple Access (NOMA) scheme, a UE using the same method, and a base station using the same method. The provided method would be applicable to both downlink and uplink transmissions. To utilized such method, a transmission power ratio between at least two UEs would be determined. The goal is to determine the best transmission power ratio which will result in having the optimal receiving power ratio of the combined signal in the receiving end. When operating under different transmission power ratios, for each transmission power ratio, a different rotation angle would be applied to each of the user data. In other words, the signal constellation of a UE could be rotated relative to another user when the signals for each UE is to be superimposed to be transported within the same physical resource.

Thus, the disclosure further proposes ways to obtain a best rotation angle of the signal constellation for each UE when all UE are combined into a superimposed signal to be received by the receiving end. After the superimposed signal is received by the receiving end, the receiver of the receiving end may decode the appropriate data content according to the transmission power ratio and the rotation angle. In order to do so, the transmitting end and the receiving end may need to know and agree in advance which power ratio and rotation angle are going to be used. The basis for calculating the rotation angle can be based on various methods such as randomly generated rotational angle, maximizing information method (MI method), and maximizing distance method (MD method) which will be elaborated further in latter disclosure.

FIG. 3 illustrates the above described concept of rotating signal constellation diagram. The first plot of FIG. 3 shows a signal constellation diagram of two signals superimposed into the same physical resource under a conventional NOMA scheme. The second plot 302 of FIG. 3 shows a signal constellation diagram of two signals superimposed into the same physical resource under the proposed NOMA scheme as each of the signal constellations are rotated by a rotational angle as shown in FIG. 3 to be θ₁ degree for the first signal and θ₂ degree for the second signal. Also, as seen in FIG. 3, two constellations under conventional NOMA scheme have a minimum distance dₘᵢₙ1 between the two constellations, the two constellations under the proposed NOMA scheme have a minimum distance dₘᵢₙ2 between the two constellations, and dₘᵢₙ2>dₘᵢₙ1.

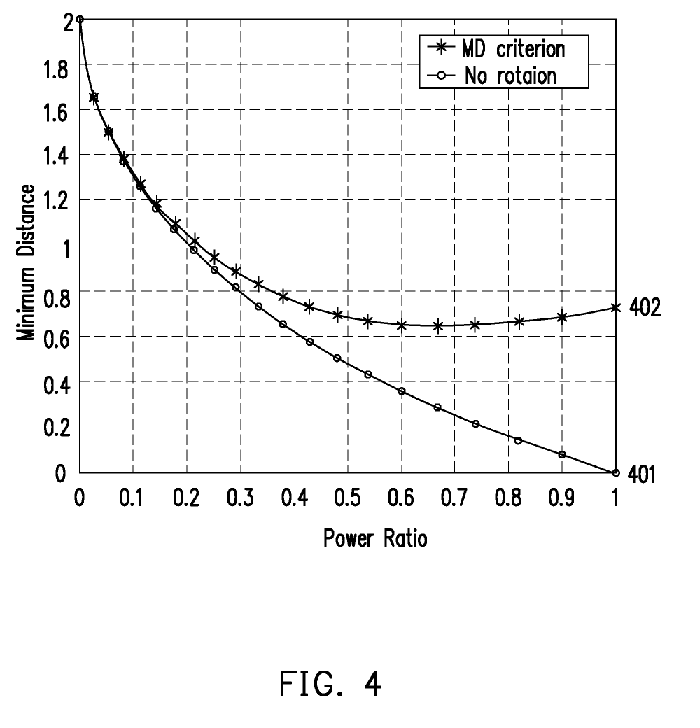

FIG. 4 illustrates a graph comparing minimum distances as a function of power ratio under two different NOMA schemes of QPSK+QPSK. By comparing the first curve 401 under the conventional NOMA and the second curve under the proposed NOMA scheme having a phase rotation of signal constellations, it can be seen that the proposed NOMA scheme would have a greater minimum distance as the power ratio becomes greater in comparison to the conventional NOMA scheme. Because the proposed NOMA scheme as shown in FIG. 3 and FIG. 4 would result in greater maximized minimum distance between the minimum constellation points than the maximized minimum distance between the minimum constellation points of a conventional NOMA scheme, the proposed NOMA scheme would result in greater signal integrity, better signal to noise ratio, and less decoding errors.

The above described rotation angle of each of the signal constellations could be determined in three way including (1) randomly selected phase in a phase vector, (2) maximizing the amount of information combined with the constellation points (mutual information), or by (3) maximizing the minimum distance between the minimum constellation points (minimum inter-distance). Method (2) will be abbreviated as MI method and method (3) will be abbreviated as MD method from this point forward.

For method (1), the rotational angle of each of the signal constellations could be determined by randomly selecting a phase in a phase vector according to Equation (1) below.

$$[ 0 , ( \frac{1}{Q - 1} ) ( π / 2 ) , ( \frac{2}{Q - 1} ) ( π / 2 ) , … , ( \frac{Q - 2}{Q - 1} ) ( π / 2 ) , π / 2 ] \qquad Equation ( 1 )$$

It should be noted that Q should be larger or equal than the maximum number of UEs or the maximum number of total applications.

For method (2), MI based rotational angle of each of the signal constellations could be determined by calculating the rotational angle, θ*_{MI}, according to Equation (2) below.

$$( {θ}_{MI}^{*} ) = arg {max}_{{θ}_{1} , {θ}_{2} , … , {θ}_{K} ∈ Θ} I ( \sqrt{{P}_{1}} {x}_{1} {e}^{i {θ}_{1}} + \sqrt{{P}_{2}} {x}_{2} {e}^{i {θ}_{2}} + … + \sqrt{{P}_{K}} {x}_{K} {e}^{i {θ}_{K}} ; y ) \qquad Equation ( 2 )$$

θ*_{MI} could be determined based on a pre-defined tables which follow the MI-maximizing-based rule as described in Equation (2). By determining the power ratio between the first signal (P1) and the second signal (P2) which are superimposed in the same physical source, the θ*_{MI} values as a function of different signal to noise ratio (SNR) in decibel (dB) can be compiled and listed in a table. Table 1 below shows an example of two UEs or two applications of QPSK+QPSK signal constellations with a power ratio of 0.8.

TABLE 1

| SNR in dB | θ*_{MI} (θ*_{MI,1}, θ*_{MI,2}) |
|---|---|
| 6 dB | (0, 0.6606) |
| 7 dB | (0, 0.6094) |
| 8 dB | (0, 0.5863) |
| 9 dB | (0, 0.5670) |
| 10 dB | (0, 0.5550) |

Table 2 below shows an example of three UEs or three applications Ex: 3-UE/application QPSK+QPSK+16QAM with power ratio 9:8:7

TABLE 2

| SNR in dB | θ*_{MI} (θ*_{MI,1}, θ*_{MI,2}, θ*_{MI,3}) |
|---|---|
| 15 dB | (0, 0.4416, 0.2310) |
| 16 dB | (0, 0.4476, 0.2392) |
| 17 dB | (0, 0.4522, 0.2405) |
| 18 dB | (0, 0.4536, 0.2478) |

For method (3), MD method based rotational angle of each of the signal constellations could be determined according to equations below to determine (θ*₁, θ*₂, . . . θ*ₖ), where θ*ₖ is the rotational angle of each of the signal constellations. Equation (3) below is for calculating (θ*₁, θ*₂) which are the rotational angle of two different UEs or two different applications

$$( {θ}_{1}^{*} , {θ}_{2}^{*} ) = arg {max}_{{θ}_{1} , {θ}_{2} ∈ Θ} {d}_{min} ( \sqrt{{P}_{1}} {x}_{1} {e}^{i {θ}_{1}} + \sqrt{{P}_{2}} {x}_{2} {e}^{i {θ}_{2}} ) \qquad Equation ( 3 )$$

The (θ*₁, θ*₂) could be dynamically calculated by finding solutions to the closed-form equation, e.g., sin⁻¹(\sqrt{P₂/P₁}) for QPSK+QPSK. However, the (θ*₁,θ*₂) could be also be determined according to a pre-defined phase table as shown in Table 3 below for an QPSK+QPSK example.

TABLE 3

| P₁/P₂ | θ*_{MD} (θ*_{MD,1}, θ*_{MD,2}) |
|---|---|
| 1 | (0, 0.5236) |
| 3 | (0, 0.2928) |
| 4 | (0, 0.2527) |
| 9 | (0, 0.1674) |

The complete expression for greater than two UEs or applications are shown in the follow expressions below:

$$\begin{matrix}( {θ}_{1}^{*} , {θ}_{2}^{*} ) = arg {max}_{{θ}_{1} , {θ}_{2} ∈ Θ} {d}_{min} ( \sqrt{{P}_{1}} {x}_{1} {e}^{i {θ}_{1}} + \sqrt{{P}_{2}} {x}_{2} {e}^{i {θ}_{2}} ) \\ {θ}_{3}^{*} = arg {max}_{{θ}_{3} ∈ Θ} {d}_{min} ( \sqrt{{P}_{1}} {x}_{1} {e}^{i {θ}_{1}^{*}} + \sqrt{{P}_{2}} {x}_{2} {e}^{i {θ}_{2}^{*}} + \sqrt{{P}_{3}} {x}_{3} {e}^{i {θ}_{3}} \vert {θ}_{1}^{*} , {θ}_{2}^{*} ) \\ ⋮ \\ {θ}_{K}^{*} = arg {max}_{{θ}_{K} ∈ Θ} {d}_{min} ( \sqrt{{P}_{1}} {x}_{1} {e}^{i {θ}_{1}^{*}} + … + \sqrt{{P}_{K}} {x}_{K} {e}^{i {θ}_{K}} \vert {θ}_{1}^{*} , … , {θ}_{K - 1}^{*} ) \\ {θ}_{MD}^{*} = ( {θ}_{1}^{*} , {θ}_{2}^{*} , … , {θ}_{K}^{*} )\end{matrix}$$

The solutions of the expressions above could be dynamically calculated by finding solutions to the closed-form equations, e.g., sin⁻¹(\sqrt{P₂/P₁}) for QPSK+QPSK. However, the solutions could be also be determined according to a pre-defined phase table as shown in Table 4 below for an QPSK+QPSK+16QAM example.

TABLE 4

| P₁:P₂:P₃ | θ*_{MD} (θ*_{MD,1}, θ*_{MD,2}, θ*_{MD,3}) |
|---|---|
| 10:6:1 | (0, 0.3977, 1.5708) |
| 10:6:4 | (0.2, 0.5977, 1.5608) |
| 9:8:7 | (0.1, 0.5636, 0.3510) |
| 9:8:6 | (0.5, 0.6674, 0.8880) |

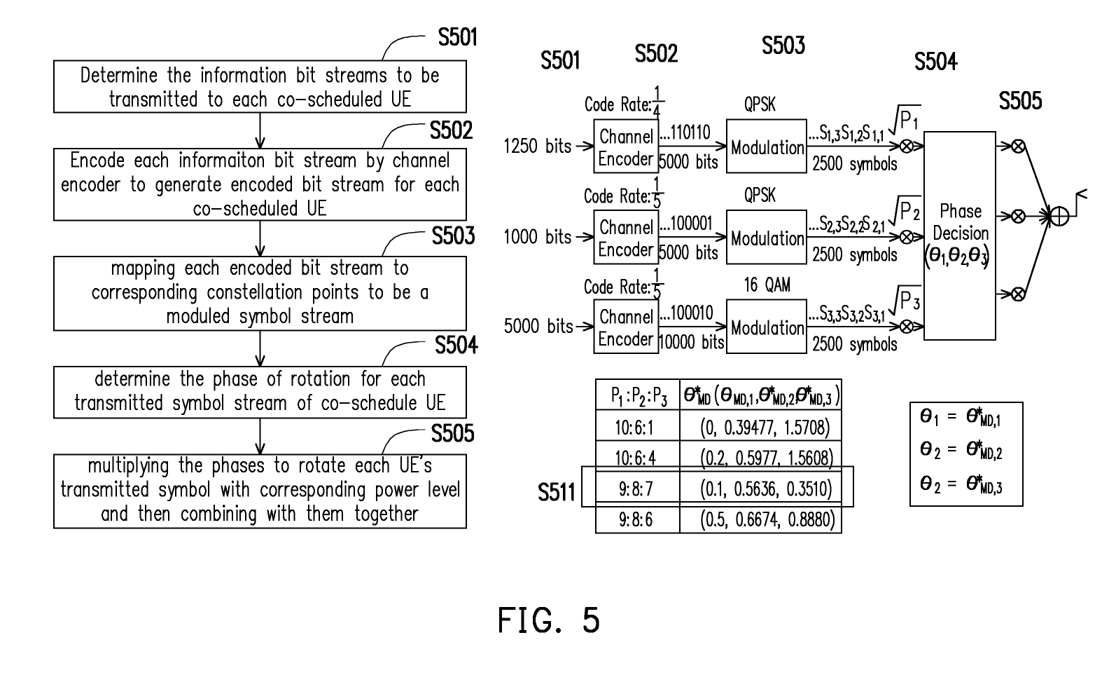

To elucidate the above described concepts, FIG. 5 illustrates a first exemplary embodiment of a method of transmitting downlink data under the NOMA scheme from a base station to multiple UEs. In step S501, the base station would determine each of the information bit streams to be transmitted to each of the corresponding co-scheduled UEs. In step S502, the base station would encode each information bit stream by channel encoder to generate encoded bit stream for each of the co-scheduled UEs. In step S503, the base station would map each encoded bit stream to corresponding constellation points to be a modulated symbol stream. In step S504, the base station would determine the phase rotation of each transmitted symbol stream of each of the co-scheduled UEs. In step S505, the base station would multiply the phases to rotate each UE's transmitted symbol with corresponding power level and then combining them together into a combined signal to be transported in the same physical resource.

For the example of FIG. 5 in which a base station transmits downlink data to three UEs, the base station would turn on a flag which indicates that the base station would perform inter-constellation rotation when operating under NOMA. The flag could be transmitted to UEs through a control channel or RRC signaling. Assuming that the base station sets the code rate of the first UE as 1/4, the code rate of the second UE as 1/5, and the code rate of the third UE as 1/2 while the modulation scheme of the first UE as QPSK, the modulation scheme of the second UE as QPSK, and the modulation scheme of the third UE as 16QAM. The power ratio among the first UE, the second UE, and the third UE (P1:P2:P3) is 9:8:7. Based on the power ratio, the base station may select the angles of rotations of each of the UEs from a pre-defined phase table which has been constructed by following the MD method which has been described under method (3) above. Moreover, the base station may also transmit information including one or more of the Modulation and Coding scheme (MCS), the power ratio, and the angles of rotations to each of the UEs via a control channel signaling or a RRC signaling. Alternatively, the base station may only inform the power ratio which allows the UEs to determine its angles of rotations (S511) via a lookup table.

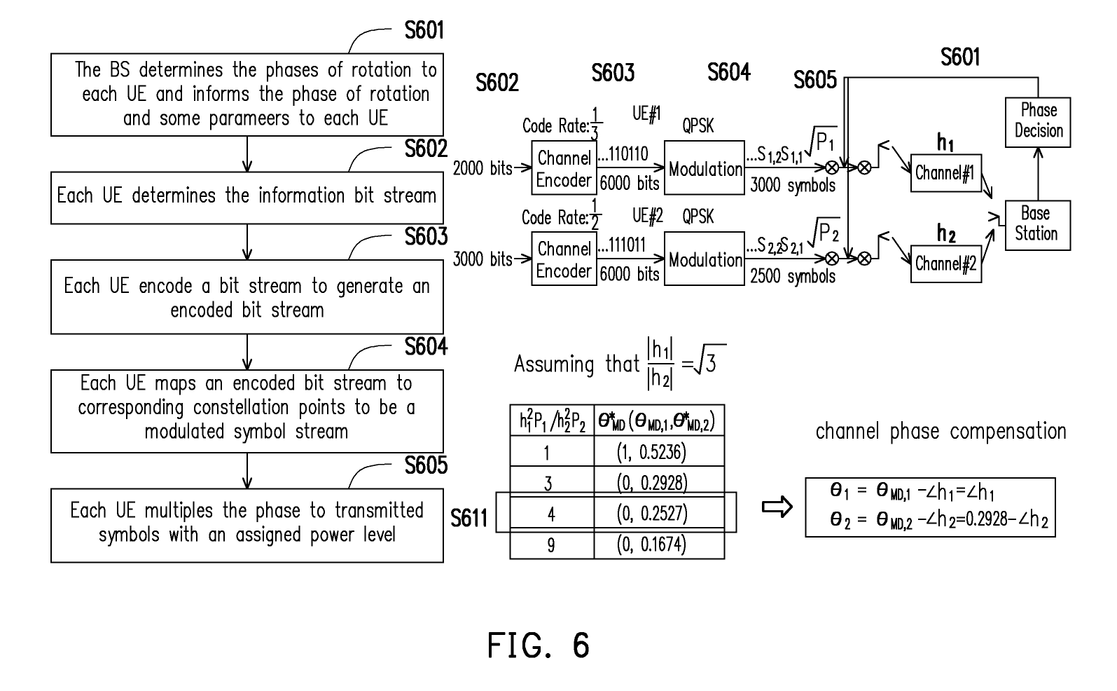

FIG. 6 illustrates a second exemplary embodiment of a method of multiple UEs transmitting uplink data to a base station under the NOMA scheme. In step S601, the base station would determine the phases of each UE and would inform the phase of rotation and some parameters to each UE. Alternatively, the base station may only inform the power ratio which allows the UEs to determine its angles of rotations via a lookup table. In step S602, Each UE would determine the information bit stream to be uplinked to the base station. In step S603, each would UE encode its information bit stream to generate an encoded bit stream. In step S604, each UE would maps the encoded bit stream to corresponding constellation points as a modulated symbol stream. In step S605, each UE would multiply the phase to transmitted symbols with an assigned power level.

Moreover, in the example of FIG. 6 which involves multiple UEs transmitting uplink data to a base station, in general, the base station would need to know the channel by obtain channel information. Assuming that there are only two UE and thus there are two channels from the two UEs to the BS, and the ratio of the channels has been determined as,

$$\frac{\vert {h}_{1} \vert}{\vert {h}_{2} \vert} = \sqrt{3} ,$$

then the base station may set the code rate of the first UE as 1/3, the code rate of the second UE as 1/2, the modulation scheme of the first UE as QPSK, the modulation scheme of the second UE as QPSK, and the power ratio (P1:P2) between the first UE and the second UE as 1:1. The angles of rotation could then be determined based on the MD method by finding a closed-form solution for

$${θ}_{1} = 0 - ∠ {h}_{1} and {θ}_{2} = {sin}^{- 1} ( \sqrt{\frac{{\vert {h}_{1} \vert}^{2} {P}_{1}}{{\vert {h}_{2} \vert}^{2} {P}_{2}}} ) - ∠ {h}_{2}$$

with the channel difference being considered. The angles of rotation could then be determined based on the MD method by a pre-defined table which was build by follows the MD method as described under method (3). In the example of FIG. 6, the angles of rotation S611 is assumed to be obtained from the pre-defined table, and subsequently the channel phase compensation could be determined. Similar to the previous exemplary embodiment, the MCS, power ratio, and the angles of rotation could be transmitted to each UE via a control channel signaling or RRC signaling.

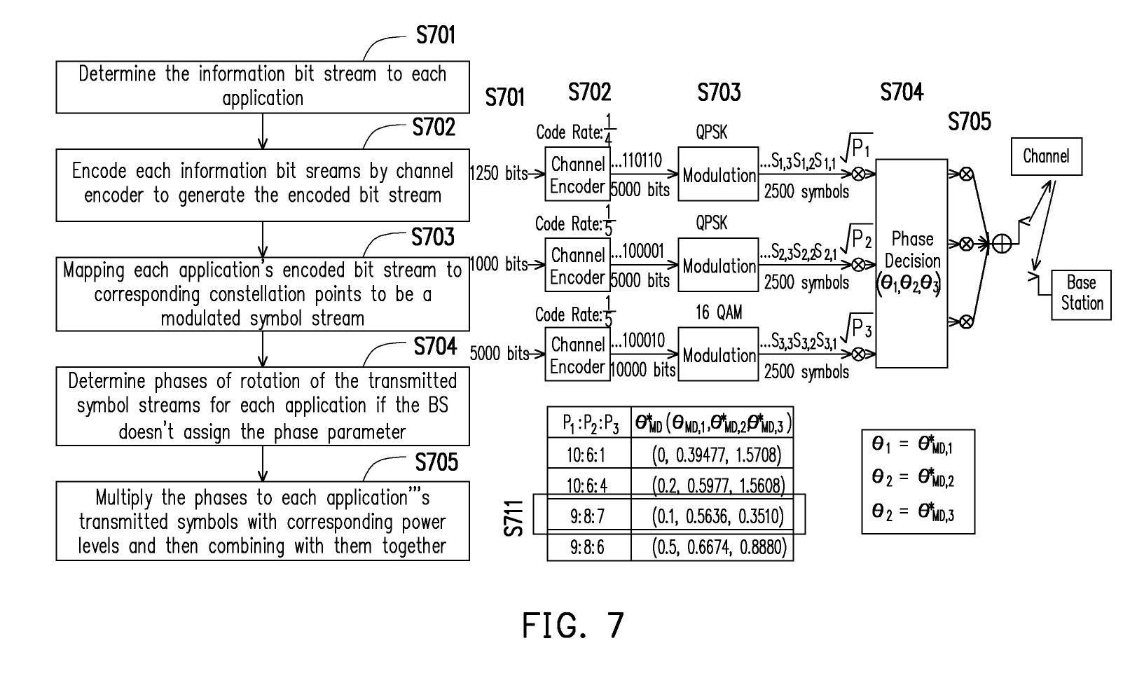

FIG. 7 illustrates a third exemplary embodiment of a method of transmitting uplink data under the NOMA scheme from multiple applications to a base station. The multiple applications could from the same UEs or could belong to different UEs. In step S701, the UE would determine each information bit stream for each of the multiple applications. In step S702, the UE would encode each information bit streams by a channel encoder to generate an encoded bit stream. In step S703, the UE would map each application's encoded bit stream to corresponding constellation points to be a modulated symbol stream. In step, S704, the UE would determine the angle of rotation for each of the transmitted symbol streams which corresponds to each application assuming that the base station doesn't assign the phase parameter. In step S705, the UE would multiply the angle of rotation to each application's transmitted symbol with the corresponding power level and then combining the transmitted symbols of all applications together to be transported in the same physical resource.

In the example of FIG. 7, the operations to be described below can be performed by either the base station or each individual UE. For instance, the UE may set the flag as ‘ON’ to indicate that the inter-constellation angles of rotation will be implemented while operating under NOMA. Assuming that the number of applications is 3, the UE may set code rate of the first application as 1/4, the code rate of the second application as 1/5, the code rate of the third application as 1/2, the modulation scheme of the first application as QPSK, the modulation scheme of the second application as QPSK, and the modulation scheme of the third application as 16QAM, and the power ratio among the three applications (P1:P2:P3) are determined to be 9:8:7. The angles of rotations (S711) for each of the three applications could be selected from a pre-defined phase table which is built following the MD method as described in method (3) above. The parameters which are not determined by the base station are to be sent to the base station via a control channel signaling or a RRC signaling. Conversely, assuming that the parameters above are not determined by a UE but was determined by a base station, the base station would then communicate the parameters to the UE via a control channel signaling or a RRC signaling.

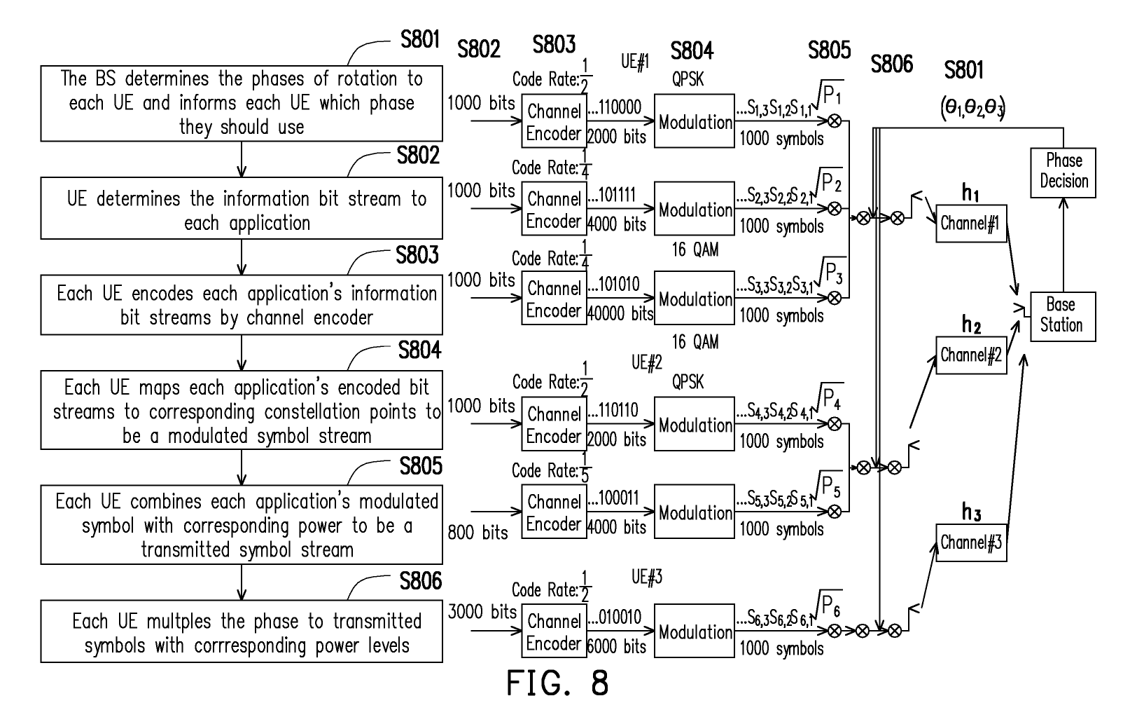

FIG. 8 illustrates a fourth exemplary embodiment of a method of multiple UEs transmitting uplink data of multiple applications under the NOMA scheme. In step S801, the base station would determine the angles of rotation to each UE and informs each UE which angle of rotation one should use. In step S802, the UE would determine the information bit stream to be transmitted for each application. In step S803, each UE would encode each application's information bit stream by a channel encoder. In step S804, each UE would map each application's encoded bit stream to corresponding constellation points as a modulated symbol stream. In step S805, each UE would combine each application's modulated symbol stream with corresponding power to be a transmitted symbol stream. In step S805, each UE would multiples the previously determined angle of rotation to each transmitted symbol with corresponding power levels.

For the example of FIG. 8, the base station would need to know the channel and thus the parameters below would need to be determined by the base station. It is assumed that the base station has set the number of applications of the first UE as 3, the number of applications of the second UE as 2, the number of applications of the third UE as 1, the code rate of the first application of the first UE as 1/2, the code rate of the second application of the first UE as 1/4, the code rate of the third application of the first UE as 1/4, the code rate of the first application of the second UE as 1/2, the code rate of the second application of the second UE as 1/5, the code rate of the third application of the third UE as 1/2, the modulation scheme of the first application of the first UE as QPSK, modulation scheme of the second application of the first UE as 16QAM, the modulation scheme of the third application of the first UE as 16QAM, the modulation scheme of the first application of the second UE as is QPSK, the modulation scheme of the second application of the second UE as 16QAM, the modulation scheme of the third application of the third UE as 64QAM, and the power levels are respectively 1, 3/5, 2/5, 1, 1/2 and P6=3/4. The angles of rotation could be determined using method (1) from the phase vector by setting Q=6 so that the phase vector

$$[ 0 , ( \frac{1}{Q - 1} ) ( π / 2 ) , ( \frac{2}{Q - 1} ) ( π / 2 ) , … , ( \frac{Q - 2}{Q - 1} ) ( π / 2 ) , π / 2 ] = [ 0 , \frac{π}{10} , \frac{2 π}{10} , \frac{3 π}{10} , \frac{4 π}{10} , \frac{π}{2} ]$$

which provides the 6 phases for 6 UEs or applications for use. Thus, in this example, from θ₁ to θ₃ can randomly be selected from a phase vector, such as

$$0 , \frac{2 π}{10} , \frac{4 π}{10}$$

which would be used for channel phase compensation.

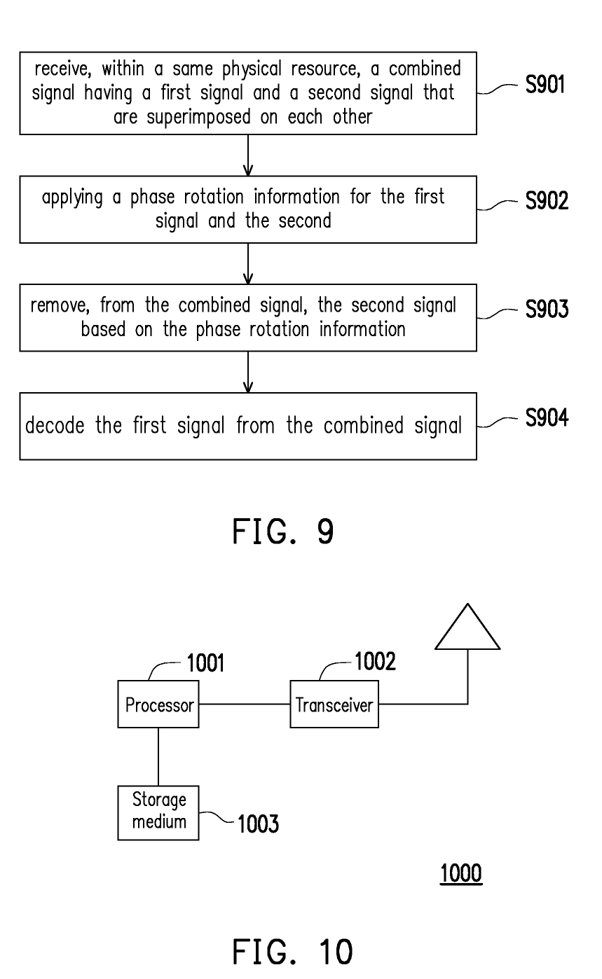

FIG. 9 illustrates a method of transmitting data under NOMA scheme from the perspective of a user equipment. In step S901, the UE would receive within the same physical resource, a combined signal having a first signal and a second signal that are superimposed on each other. The physical resource could be a time slot, frequency band, space, etc. In step S902, the UE would apply a phase rotation information for the first signal and the second signal. In step S903, the UE would remove, from the combined signal, the second signal based on the phase rotation information. In step S904, the UE would decode the first signal from the combined signal.

Regarding step S902, there are multiple exemplary embodiments which could implemented based on different scenarios. According to FIG. 6 which involves multiple UEs but single application, the base station determines the phase rotation information and transmit to each UE, and thus the UE would apply a phase rotation information according to information received from the base station. According to FIG. 7 which involves single UE with multiple applications, the UE would determine the phase rotation information for each application and transmit the combined signal by using the phase rotation information to the base station. In FIG. 8 which involves the multiple UEs and multiple applications, a UE would use a previously determined power ratio and generate a combined signal from each of the multiple applications by using the power ratio as combined signal contains multiple modulated signal under vaiours modulation schemes such as (QPSK, 16QAM, 64 QAM, etc.). Subsequently the UE would use the phase angle rotation which was determined by the base station to multiply with the combined signal before transmitting the phase rotated combined signal to the base station.

In one of the exemplary embodiments, the above described determining the phase rotation information may include determining a power ratio between the first signal and the second signal and determining the phase rotation information based on the power ratio, wherein phase rotation information includes a first phase angle of a first signal constellation of the first signal and a second phrase angle of a second signal constellation of the second signal.

In one of the exemplary embodiments, the above described determining the phase rotation information based on the power ratio may include determining the phase rotation information based on the power ratio from a lookup table which is stored in the UE. Each entry of the lookup table may contain a different power ratio and, the first phase angle of the first signal and the second phase angle of the second signal corresponding to the different power ratio. Each entry of the lookup table could be predetermined based on one of several schemes including a randomly selected phase in a phase vector, maximizing a minimum distance between constellation points of the second signal constellation and maximizing information combined with the constellation points of the second signal constellation.

In one of the exemplary embodiments, the above described determining the phase rotation information may include receiving the phase rotation information from a base station. The above described determining the phase rotation information may further include receiving one of power level information of each of the first signal and the second signal, modulation and coding scheme (MCS) of each of the first signal and the second signal, and a flag which indicates that phase rotations of the first signal and the second signal are currently being applied.

In one of the exemplary embodiments, the first signal is intended for UE, but the second signal is intended for a different UE. Alternatively, the first signal is for a first application of the UE, and the second signal is for a second application of the same UE. In one of the exemplary embodiments, the combined signal further includes a third signal and each different power ratio of each entry of the lookup table further corresponds to a third phrase angle of the third signal.

FIG. 10 illustrates a hardware diagram of a user equipment in terms of functional block diagrams in accordance with one of the exemplary embodiments of the disclosure. The exemplary UE 1000 would include not limited to a hardware processor 1001 electrically connected to at least a hardware transceiver 1002 and a non-transitory storage medium 1003. The hardware processor 1001 is configured at least to receive, within the same physical resource through the hardware transceiver 1002, a combined signal having a first signal and a second signal that are superimposed on each other, apply a phase rotation information for the first signal and the second signal, remove, from the combined signal, the second signal based on the phase rotation information, and decode the first signal from the combined signal.

The term “user equipment” (UE) in this disclosure may be, for example, a mobile station, an advanced mobile station (AMS), a server, a client, a desktop computer, a laptop computer, a network computer, a workstation, a personal digital assistant (PDA), a tablet personal computer (PC), a scanner, a telephone device, a pager, a camera, a television, a hand-held video game device, a musical device, a wireless sensor, and the like. In some applications, a UE may be a fixed computer device operating in a moving environment, such as a bus, a train, an airplane, a boat, a car, and so forth.

The hardware transceiver 1002 would include a transmitter and a receiver and could be configured to operate in the radio frequency or millimeter wave (mmWave) frequency and may also perform operations such as low noise amplifying, impedance matching, frequency mixing, up or down frequency conversion, filtering, amplifying, and so forth. The hardware transceiver 1002 may each include one or more analog-to-digital (A/D) and digital-to-analog (D/A) converters which are configured to convert from a digital signal format to an analog signal format during uplink signal processing and from an analog signal format to digital signal format during downlink signal processing. The hardware transceiver 1002 may further include an antenna array which has multiple antennas capable of transmitting and receiving omni-directional beams or directional antenna beams. The hardware transceiver 1002 may contain one or more transceivers for communicating in the same or other licensed or unlicensed spectrum.

The hardware processor 1001 is configured to process digital signals and to perform procedures of the proposed method of transmitting data under the disclosed power NOMA scheme. The hardware processor 1001 could be implemented by using programmable units such as a micro-processor, a micro-controller, a DSP chips, FPGA, etc. The functions of the processor(s) may also be implemented with separate electronic devices or ICs. It should be noted that the functions of hardware processor 1001 may be implemented with either hardware or software. Also, the hardware processor 1001 may access to a non-transitory storage medium 103 which stores programming codes, codebook configurations, buffered data, or record configurations assigned by the hardware processor 1001. For example, the non-transitory storage medium 103 could be used to store the above described lookup table.

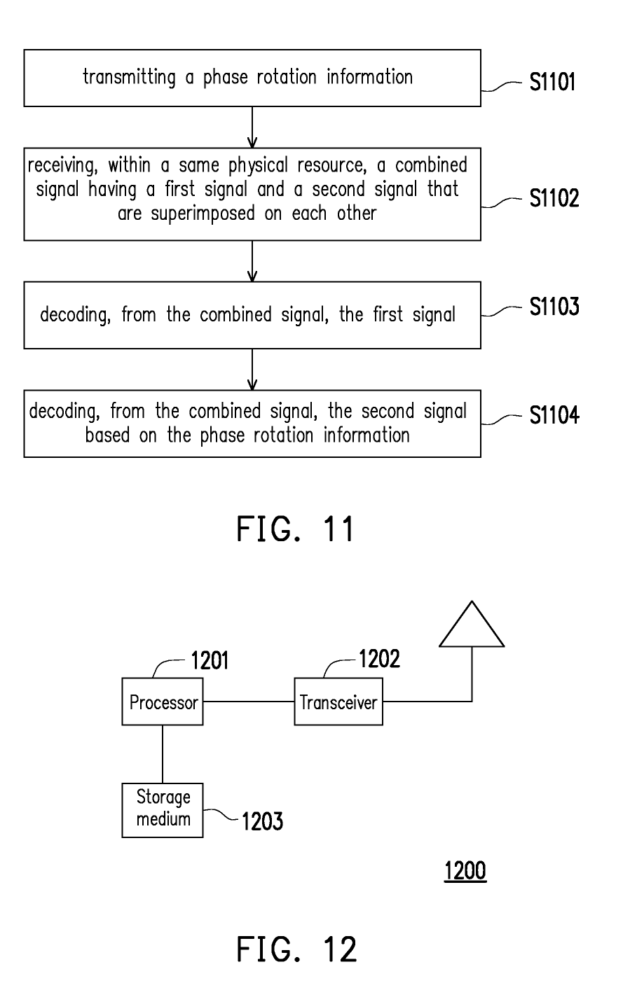

FIG. 11 illustrates a method of transmitting data under NOMA scheme from the perspective of a base station. In step S1101, the base station would transmit a phase rotation information. In step S1102, the base station would receive within the same physical resource, a combined signal having at least a first signal and a second signal that are superimposed on each other. The physical resource could be a time slot, frequency band, space, etc. In step S1103, the base station would decode, from the combined signal, the first signal. In step S1104, the base station would decode, from the combined signal, the second signal based on the phase rotation information.

In one of the exemplary embodiments, before transmitting the phase rotation information, the base station may determine the phase rotation information based on a power ratio between the first signal and the second signal. The rotation information may include a first phase angle of a first signal constellation of the first signal and a second phrase angle of a second signal constellation of the second signal. The base station determining the phase rotation information based on the power ratio between the first signal and the second signal may further include determining the phase rotation information based on the power ratio from a lookup table which is stored in the base station.

In one of the exemplary embodiments, each entry of the lookup table may contain a different power ratio and the corresponding first phase angle of the first signal and the corresponding second phase angle of the second signal. Each entry of the lookup table may have been predetermined based on a randomly selected phase in a phase vector, by maximizing a minimum distance between constellation points of the second signal constellation, or by maximizing mutual information combined with the constellation points of the second signal constellation.

In one of the exemplary embodiments, in addition to transmitting a phase rotation information, the base station may further transmit one of a power level information of each of the first signal and the second signal, a modulation and coding scheme (MCS) of each of the first signal and the second signal, and a flag which indicates that phase rotations of the first signal and the second signal are currently being applied.

In one of the exemplary embodiments, the first signal is intended for a first UE and the second signal is intended for a second UE. Alternatively, the first signal is intended for a first application of a first UE and the second signal is intended for a second application of the same first UE. In one of the exemplary embodiments, the combined signal further includes a third signal and each different power ratio of each entry of the lookup table further corresponds to a third phrase angle of the third signal.

FIG. 12 illustrates a hardware diagram of a base station in terms of functional block diagrams in accordance with one of the exemplary embodiments of the disclosure. The base station may include not limited to a hardware processor 1201, a hardware transceiver 1202, and a non-transitory storage medium 1203. The hardware processor 1201 are electrically connected to the hardware transceiver 1202 and the non-transitory storage medium 1203 and configured at least for transmitting a phase rotation information, receiving, within a same physical resource, a combined signal comprising a first signal and a second signal that are superimposed on each other, decoding, from the combined signal, the first signal, and decoding, from the combined signal, the second signal based on the phase rotation information.

The term base station (BS) in this disclosure could be synonymous, for example, with a variation or a sub-variation of a gNB, an “eNodeB” (eNB), a Node-B, an advanced base station (ABS), a base transceiver system (BTS), an access point, a home base station, a relay station, a scatterer, a repeater, an intermediate node, an intermediary, satellite-based communication base stations, and so forth.

The hardware transceiver 1202 may include one or more transmitters and receivers configured to transmit and receive signals respectively in the radio frequency or in the mmWave frequency. The hardware transceiver 1202 may also perform operations such as low noise amplifying, impedance matching, frequency mixing, up or down frequency conversion, filtering, amplifying, and so forth. The hardware transceiver 1202 may each include one or more analog-to-digital (A/D) and digital-to-analog (D/A) converters which are configured to convert from an analog signal format to a digital signal format during uplink signal processing and from a digital signal format to an analog signal format during downlink signal processing. The hardware transceiver 1202 may further include an antenna array which may include one or multiple antennas to transmit and receive omni-directional antenna beams or directional antenna beams.

The hardware processor 1201 is configured to process digital signals and to perform procedures of the proposed method of network slicing in accordance with the proposed exemplary embodiments of the disclosure. Also, the hardware processor 1201 may access to the non-transitory storage medium 1203 which stores programming codes, codebook configurations, buffered data, record configurations assigned by the hardware processor 1201, and the above describe lookup table. The hardware processor 1201 could be implemented by using programmable units such as a micro-processor, a micro-controller, a DSP chips, FPGA, etc. The functions of the hardware processor 1201 may also be implemented with separate electronic devices or ICs. It should be noted that the functions of hardware processor 1201 may be implemented with either hardware or software.

In view of the aforementioned descriptions, the present disclosure is suitable for being used in a wireless communication system and is able to more accurately decode multiple sets of information that are transported within the same physical resource than the conventional power based NOMA scheme by introducing a phase rotation of signal constellations for each information of the multiple sets of information.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

In all the drawings of the present disclosure, a box enclosed by dotted lines would mean an optional functional element or an optional step, and a dotted line may mean that the process flow could be optional or may not necessarily occur.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method of receiving data by a UE which operates under a Non-Orthogonal Multiple Access (NOMA) scheme, the method comprising:
receiving, within a same physical resource, a combined signal comprising a first signal and a second signal that are superimposed on each other;
applying a phase rotation information for the first signal and the second signal;
removing, from the combined signal, the second signal based on the phase rotation information; and
decoding the first signal from the combined signal.

2. The method of claim 1, wherein determining the phase rotation information comprising:
determining a power ratio between the first signal and the second signal; and
determining the phase rotation information based on the power ratio, wherein phase rotation information comprises a first phase angle of a first signal constellation of the first signal and a second phrase angle of a second signal constellation of the second signal.

3. The method of claim 2, wherein determining the phase rotation information based on the power ratio comprising:
determining the phase rotation information based on the power ratio from a lookup table which is stored in the UE.

4. The method of claim 3, wherein each entry of the lookup table contains a different power ratio and, the first phase angle of the first signal and the second phase angle of the second signal corresponding to the different power ratio.

5. The method of claim 4, wherein the each entry of the lookup table has been predetermined based on a randomly selected phase in a phase vector, by maximizing a minimum distance between constellation points of the second signal constellation, or by maximizing information combined with the constellation points of the second signal constellation.

6. The method of claim 1, wherein determining the phase rotation information comprising:
receiving the phase rotation information from a base station.

7. The method of claim 2, wherein determining the phase rotation information further comprising:
receiving one of:
power level information of each of the first signal and the second signal,
modulation and coding scheme (MCS) of each of the first signal and the second signal, and
a flag which indicates that phase rotations of the first signal and the second signal are currently being applied.

8. The method of claim 1, wherein the first signal is for UE and the second signal is for a different UE.

9. The method of claim 1, wherein the first signal is for a first application of the UE and the second signal is for a second application of the same UE.

10. The method of claim 4, wherein the combined signal further comprises a third signal and each different power ratio of each entry of the lookup table further corresponds to a third phrase angle of the third signal.

11. A method of transmitting data by a base station which operates under a Non-Orthogonal Multiple Access (NOMA) scheme, the method comprising:
transmitting a phase rotation information;
receiving, within a same physical resource, a combined signal comprising a first signal and a second signal that are superimposed on each other;
decoding, from the combined signal, the first signal; and
decoding, from the combined signal, the second signal based on the phase rotation information.

12. The method of claim 11, wherein before transmitting the phase rotation information, further comprising:
determining the phase rotation information based on a power ratio between the first signal and the second signal, wherein the rotation information comprises a first phase angle of a first signal constellation of the first signal and a second phrase angle of a second signal constellation of the second signal.

13. The method of claim 12, wherein determining the phase rotation information based on the power ratio between the first signal and the second signal further comprising:
determining the phase rotation information based on the power ratio from a lookup table which is stored in the base station.

14. The method of claim 13, wherein each entry of the lookup table contains a different power ratio and, the first phase angle of the first signal and the second phase angle of the second signal corresponding to the different power ratio.

15. The method of claim 14, wherein the each entry of the lookup table has been predetermined based on a randomly selected phase in a phase vector, by maximizing a minimum distance between constellation points of the second signal constellation, or by maximizing information combined with the constellation points of the second signal constellation.

16. The method of claim 11, wherein transmitting a phase rotation information further comprising:
transmitting one of
power level information of each of the first signal and the second signal,
modulation and coding scheme (MCS) of each of the first signal and the second signal, and
a flag which indicates that phase rotations of the first signal and the second signal are currently being applied.

17. The method of claim 11, wherein the first signal is for a first UE and the second signal is for a second UE.

18. The method of claim 11, wherein the first signal is for a first application of a first UE and the second signal is for a second application of the same first UE.

19. The method of claim 14, wherein the combined signal further comprises a third signal and each different power ratio of each entry of the lookup table further corresponds to a third phrase angle of the third signal.

20. A UE comprising:
a hardware transceiver; and
a hardware processor electrically connected to the hardware transceiver and configured at least to:
receive, within a same physical resource through the hardware transceiver, a combined signal comprising a first signal and a second signal that are superimposed on each other;
apply a phase rotation information for the first signal and the second signal;
remove, from the combined signal, the second signal based on the phase rotation information; and
decode the first signal from the combined signal.
